(19) United States
(12) Patent Application Publication
(10) Pub. No.: US 2025/0148666 A1
(43) Pub. Date: May 8, 2025

(54) TECHNIQUES FOR GENERATING AND DISPLAYING TREEMAPS REPRESENTING HIERARCHICAL DATASETS

(71) Applicant: AUTODESK, INC., San Francisco, CA (US)

(72) Inventors: Justin Frank MATEJKA, Newmarket (CA); Michael CHEN, Toronto (CA); George William FITZMAURICE, Toronto (CA)

(21) Appl. No.: 18/930,803

(22) Filed: Oct. 29, 2024

Related U.S. Application Data
(60) Provisional application No. 63/596,573, filed on Nov. 6, 2023.

(51) Int. Cl. G06T 11/20; G06F 16/248

(52) U.S. Cl. CPC G06T 11/206; G06F 16/248; G06T 2200/24

(57) ABSTRACT

A technique for generating and displaying treemaps representing tree hierarchies, including receiving, via a treemap user interface, a user selection to view a treemap of a tree hierarchy, determining, for a first parent node included in a plurality of nodes of the tree hierarchy, a total number of descendent nodes of the first parent node within the tree hierarchy, computing, for the first parent node, a first size of a first box based on the total number of descendent nodes of the first parent node, and displaying to the user, via the treemap user interface, the treemap that represents the tree hierarchy and includes the first box, wherein the first box represents the first parent node and has the first size.

### CROSS-REFERENCE TO RELATED APPLICATIONS

The present application claims the benefit of U.S. Provisional Application titled, “TECHNIQUES FOR GENERATING AND DISPLAYING THE STRUCTURES OF HIERARCHICAL DATASETS,” filed on Nov. 6, 2023, and having Ser. No. 63/596,573. The subject matter of this related application is hereby incorporated herein by reference.

### BACKGROUND

### Field of the Various Embodiments

The various embodiments relate generally to computer science and data science and, more specifically, to techniques for generating and displaying treemaps representing hierarchical datasets.

### Description of the Related Art

Hierarchical datasets can specify tree hierarchies that organize and categorize a plurality of items/objects via a plurality of interconnected nodes that are arranged in parent-child relationships. Each node can be a leaf node that does not include a child node or a parent node that includes at least one child node that can be either a leaf node or another parent node. A parent node, such as a category or classification, represents an hierarchy organizational element that is used to provide relationship structure to the tree hierarchy and logically organize the items within the tree hierarchy. A leaf node represents an item included in the plurality of items that is organized by the tree hierarchy.

There are two general types of tree hierarchies, a common hierarchy and an inclusive hierarchy. A common hierarchy is a tree hierarchy where a category is solely an hierarchy organizational element and is not also an item/object that is organized by the tree hierarchy. For example, a file system is a common hierarchy that organizes and categorizes a plurality of files (items) of a computer via a plurality of folders (categories). Each folder in the file system is only an hierarchy organizational element and is not an actual file (item/object) of the computer. In contrast, an inclusive hierarchy is a tree hierarchy where a category is both an hierarchy organizational element and an item/object that is organized by the tree hierarchy. For example, a company reporting structure is an inclusive hierarchy that organizes and categorizes a plurality of employees (items) of a company via a plurality of managers (categories). In this type of hierarchy, each manager (category) is both a hierarchy organizational element and also an employee (item) of the company.

A tree hierarchy, whether a common hierarchy or an inclusive hierarchy, can be visually represented by a conventional treemap that displays the tree hierarchy as a plurality of nested boxes/containers that represent the plurality of nodes of the tree hierarchy. A box included in the treemap can represent a parent node (category) or a leaf node (item) within the tree hierarchy. The size of each box representing a leaf node in the treemap is the smallest sized box in the treemap. In contrast, the size of each box representing a parent node is determined based on a number of descendent nodes that are leaf nodes (items) included under the parent node. In general, a box representing a parent node including a larger number of leaf nodes (items) should appear larger in the treemap than another box representing another parent node that includes a smaller number of leaf nodes (items). However, when computing the size of a particular box representing a particular parent node within a tree hierarchy, a conventional algorithm for generating and displaying the conventional treemap does not consider/count the number of descendent nodes that are parent nodes (categories) included under the particular parent node and only considers/counts the number of descendent nodes that are leaf nodes (items) of the particular parent node. This deficiency with conventional algorithms can cause problems.

In this regard, a drawback of a conventional treemap when representing a common hierarchy is that the conventional treemap does not accurately represent the hierarchical structure of the common hierarchy. For example, as displayed in a conventional treemap user interface (UI), a first box representing a first parent node that includes no categories (parent nodes) and one item (leaf node) oftentimes has the same size as a second box representing a second parent node that includes multiple levels of categories (parent nodes) that end in one item (leaf node). As such, for the user to understand and compare the depth of the hierarchical structures represented by the two different boxes, the user usually has to interact repeatedly with a property panel of the conventional treemap UI that displays the properties associated with selected nodes, such as parent-child relationships. For example, to determine the hierarchical structure for the first box, the user can input the first parent node into the property panel, which then specifies that the first parent node includes one descendent node. The user subsequently can input the one descendent node into the property panel, which then specifies that the one descendent node is an item (leaf node). To determine the hierarchical structure for the second box, the user can input the second parent node into the property panel, which then specifies that the second parent node includes a first descendent node. The user subsequently can input the first descendent node into the property panel, which then specifies that the first descendent node includes a second descendent node. The user can further input the second descendent node into the property panel, which then specifies that the second descendent node includes a third descendent node. The user also can input the third descendent node into the property panel, which then specifies that the third descendent node is an item (leaf node). Thus, with conventional treemaps representing common hierarchies, a user is required to repeatedly interact with the treemap UI to drill down through multiple layers of node properties to retrieve the desired hierarchical structure information for the different boxes included in the conventional treemap in order to understand the relationships set forth in a common hierarchy. Such an approach is tedious and inefficient and reduces the user's ability to interact effectively with the computer, thereby reducing the computer's effectiveness as a tool for the user and reducing the efficiency in the functioning of the computer itself.

Similarly, a drawback of a conventional treemap when representing an inclusive hierarchy is that the sizes of the boxes in the conventional treemap do not accurately represent the number of actual items associated with each of the boxes in the conventional treemap. For example, as displayed in a conventional treemap user interface (UI), a first box representing a first parent node that includes no categories (parent nodes) and one item (leaf node) oftentimes has the same size as a second box representing a second parent node that includes multiple levels of categories (parent nodes) that end in one item (leaf node). As such, for the user to determine and compare an accurate count of the actual items represented by the two different boxes, the user usually has to interact repeatedly with the property panel of the conventional treemap UI to retrieve the desired information. For example, to determine the number of actual items associated with the first box, the user can input the first parent node into the property panel, which then specifies that the first parent node includes one descendent node. The user subsequently can input the one descendent node into the property panel, which then specifies that the one descendent node is an item (leaf node). In this manner, the user can determine that only one item is associated with the first box. To determine the number of actual items associated with the second box, the user can input the second parent node into the property panel, which then specifies that the second parent node includes a first descendent node. The user subsequently can input the first descendent node into the property panel, which then specifies that the first descendent node includes a second descendent node. The user can further input the second descendent node into the property panel, which then specifies that the second descendent node includes a third descendent node. The user also can input the third descendent node into the property panel, which then specifies that the third descendent node is an item (leaf node). In this manner, the user can determine that there are actually three items associated with the second box. Thus, with conventional treemaps representing inclusive hierarchies, a user is required to repeatedly interact with the treemap UI to drill down through multiple layers of node properties to retrieve the desired information for the different boxes included in the conventional treemap in order to determine the number of actual items associated with the different boxes. Such an approach is tedious and inefficient and reduces the user's ability to interact effectively with the computer, thereby reducing the computer's effectiveness as a tool for the user and reducing the efficiency in the functioning of the computer itself.

As the foregoing illustrates, what is needed in the art are more effective techniques for generating and displaying treemaps representing hierarchical datasets.

### SUMMARY

Various embodiments include a computer-implemented method for generating and displaying treemaps representing tree hierarchies. The computer-implemented method includes including receiving, via a treemap user interface, a user selection to view a treemap of a tree hierarchy, determining, for a first parent node included in a plurality of nodes of the tree hierarchy, a total number of descendent nodes of the first parent node within the tree hierarchy, computing, for the first parent node, a first size of a first box based on the total number of descendent nodes of the first parent node, and displaying to the user, via the treemap user interface, the treemap that represents the tree hierarchy and includes the first box, wherein the first box represents the first parent node and has the first size.

At least one technical advantage of the disclosed techniques relative to the prior art is that the disclosed techniques generate and display category-counted treemaps that more accurately represent hierarchical datasets relative to conventional approaches. In particular, a category-counted treemap visually represents a tree hierarchy (hierarchical dataset) as a plurality of nested boxes that represent the plurality of nodes of the tree hierarchy. A box of the category-counted treemap can represent a parent node (category) or leaf node (item) of the tree hierarchy. The size of each box representing a particular parent node is determined based on a total number of descendant nodes of the particular parent node that are either parent nodes (categories) or leaf nodes (items). In this manner, the disclosed techniques count each descendent node of the particular parent node that is a parent node (categories) as an item when computing the box size for the particular parent node in the treemap.

As applied to a common hierarchy, the disclosed techniques generate and display a category-counted treemap that more accurately represents the hierarchical structure of the common hierarchy than a conventional treemap. For example, a first box representing a first parent node that includes one leaf node (item) will have a smaller computed size than a second box representing a second parent node that includes multiple hierarchy levels/generations of descendent nodes that are parent nodes (categories) that end in one leaf node (item). The smaller size of the first box compared to the second box indicates to the user quickly and efficiently that the second box is associated with a larger number of hierarchical levels/generations than the first box. Therefore, as applied to a common hierarchy, the disclosed techniques allow the user to immediately and efficiently view and compare the hierarchical structures associated with the various boxes of the category-counted treemap, without requiring the user to repeatedly interact with a conventional treemap UI to drill down through multiple layers of node properties in order to understand the relationships in a common hierarchy. Thus, the disclosed techniques enhance the user's ability to interact effectively with the computer, thereby increasing the computer's effectiveness as a tool for the user and the efficiency of the functioning of the computer itself.

As applied to an inclusive hierarchy, the disclosed techniques generate and display a category-counted treemap that more accurately represents the number of actual items associated with each box of the category-counted treemap. For example, a first box representing a first parent node that includes one leaf node (item) will have a smaller computed size than a second box representing a second parent node that includes multiple hierarchy levels/generations of descendent nodes that are parent nodes (categories) that end in one leaf node (item). The smaller size of the first box compared to the second box indicates to the user quickly and efficiently that the second box is associated with a larger number of actual items than the first box. Therefore, as applied to an inclusive hierarchy, the disclosed techniques allow the user to immediately and efficiently view and compare the number of actual items associated with the various boxes of the category-counted treemap, without requiring the user to repeatedly interact with a conventional treemap UI to drill down through multiple layers of node properties. Thus, the disclosed techniques enhance the user's ability to interact effectively with the computer, thereby increasing the computer's effectiveness as a tool for the user and the efficiency of the functioning of the computer itself.

These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 is an exemplar screenshot of a category-counted treemap displayed in the treemap UI of FIG. 1, according to various embodiments;

FIG. 3 is an exemplar screenshot of a first selected box of the category-counted treemap of FIG. 2, according to various embodiments;

FIG. 4 is an exemplar screenshot of a second selected box of the category-counted treemap of FIG. 2, according to various embodiments;

FIG. 5 illustrates a treemap representation of a parent node that includes a single direct child node, according to the prior art;

FIG. 6 illustrates an offset nesting technique applied to a first node scenario of a tree hierarchy, according to various embodiments;

FIG. 7 illustrates an offset nesting technique applied to a second node scenario of a tree hierarchy, according to other various embodiments;

FIG. 8 illustrates an offset nesting technique applied to a third node scenario of a tree hierarchy, according to other various embodiments;

FIG. 9 is an exemplar screenshot of a search function implemented via the category-counted treemap, according to various embodiments;

FIG. 10 is an exemplar screenshot of the treemap UI that includes an information card section and the category-counted treemap, according to various embodiments; and

FIGS. 11A-B set forth a flow diagram of method steps for generating and displaying a category-counted treemap representing a tree hierarchy, according to various embodiments.

### DETAILED DESCRIPTION

In the following description, numerous specific details are set forth to provide a more thorough understanding of the various embodiments. However, it will be apparent to one of skilled in the art that the inventive concepts can be practiced without one or more of these specific details.

### System Overview

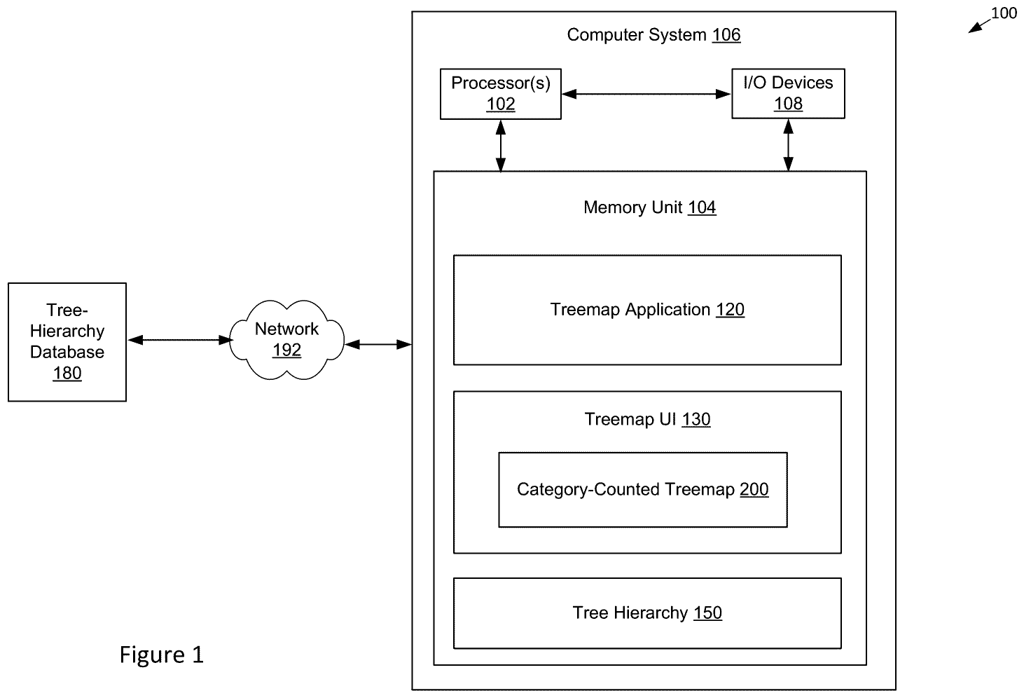

FIG. 1 illustrates a system 100 configured to implement one or more aspects of the various embodiments. As shown, the IE system 100 includes, without limitation, a computer system 106 and a tree-hierarchy database 180 connected via a network 192, which may be a wide area network (WAN) such as the Internet, a local area network (LAN), or any other suitable network. The tree-hierarchy database 180 can store various hierarchical datasets that specify various tree hierarchies that can be loaded to the computer system 106 for processing, in accordance with the embodiments described herein. For example, a particular tree hierarchy can be loaded to the computer system 106 in response to receiving, via the treemap UI, a user selection to view a treemap representing the particular tree hierarchy.

The computer system 106 can comprise at least one processor 102, input/output (I/O) devices 108, and a memory unit 104 coupled together. The computer system 106 can comprise a server, personal computer, laptop or tablet computer, mobile computer system, or any other device suitable for practicing various embodiments described herein. For example, the computer system 106 can comprise a cloud server to generate and display category-counted treemaps as a cloud service to other computer systems on the network 192. In general, each processor 102 can be any technically feasible processing device or hardware unit capable of processing data and executing software applications and program code. Each processor 102 executes the software and performs the functions and operations set forth in the embodiments described herein. For example, the processor(s) 102 can comprise general-purpose processors (such as a central processing unit), special-purpose processors (such as a graphics processing unit), application-specific processors, field-programmable gate arrays, or other programmable logic device, discrete gate or transistor logic, discrete hardware components, or any combination of different processing units.

The memory unit 104 can include a hard disk, a random access memory (RAM) module, a flash memory unit, or any other type of memory unit or combination thereof. Processor 102 and I/O devices 108 read data from and write data to memory 104. The memory unit 104 stores software application(s) and data. Instructions from the software constructs within the memory unit 104 are executed by processors 102 to enable the inventive operations and functions described herein.

I/O devices 108 are also coupled to memory 104 and can include such devices as a network card for connecting with a network 192, a fabrication device (such as a 3D printer), and so forth. The I/O devices 108 can also include input devices capable of receiving user inputs, such as a keyboard, a mouse, a trackball, a camera for inputting images and/or video, a microphone for inputting audio, and so forth, as well as output devices capable of providing output, such as a display, speaker, and so forth. Additionally, I/O devices can include devices capable of both receiving input and providing output, such as an augmented reality (AR) system, virtual reality (VR) system, touchscreen, a universal serial bus (USB) port, and so forth.

The memory unit 104 stores a treemap application 120, a treemap UI 130, and a tree hierarchy 150. The treemap application 120 generates and displays the treemap UI 130 and provides the underlying functionality of the treemap UI 130 described herein. The treemap application 120 can receive, via the treemap UI 130, a user selection to view a category-counted treemap 200 for a particular tree hierarchy 150, and in response, load the particular tree hierarchy 150 from the tree-hierarchy database 180. The treemap application 120 then performs operations on the tree hierarchy 150 to generate a category-counted treemap 200 representing the tree hierarchy 150 and displays the generated category-counted treemap 200 in the treemap UI 130. The tree hierarchy 150 can be, for example, downloaded from the tree-hierarchy database 180 that stores various hierarchical datasets that specify various tree hierarchies, including common hierarchies and inclusive hierarchies, that can be loaded to the computer system 106 for processing.

For example, for a tree hierarchy, a corresponding hierarchical dataset can specify metadata describing a plurality of interconnected nodes including a root node, each parent node (category), and each leaf node (item) of the tree hierarchy and the interconnections and parent-child relationships between the various nodes that provide a hierarchical structure of the tree hierarchy. Each node of the tree hierarchy has an associated name/identifier, such as a category name or item name. The tree hierarchy is for organizing a plurality of items/objects using hierarchy organizational elements comprising categories (which can also be referred to as classifications or containers). An item/object comprises a leaf node that includes no other nodes of the tree hierarchy and a category comprises a parent node that includes at least one other child node that can be another parent node or a leaf node of the tree hierarchy. A category is considered an hierarchy organizational element since a category is an element that is used to structure the tree hierarchy into different branches and hierarchy levels and organize the leaf nodes (items) of the tree hierarchy.

The plurality of interconnected nodes of the tree hierarchy are organized as a plurality of different hierarchy levels, each level being defined based on a hop distance to the root node of the tree hierarchy. As used herein, a “category_1” node is a root node of the tree hierarchy for a category placed at a first top level of the tree hierarchy. A “category_2” node is a direct child node of the root node for a category placed at a second level of the tree hierarchy, and is one node hop from the root node. A “category_3” node is a direct child node of a category_2 node for a category placed at a third level of the tree hierarchy and is two node hops from the root node. A “category_4” is a direct child node of a category_3 node for a category placed at a fourth level of the tree hierarchy and is three node hops from the root node, and so forth. A leaf node of the tree hierarchy is a terminal node that represents an hierarchy item/object. In a line of direct ascendants from the leaf node to the root node, the leaf node is at the highest hierarchy level within this line of direct ascendants. Descendent nodes of a parent node include all children nodes, grand-children nodes, great-grand-children nodes, and so forth. Ascendent nodes of a child node include all parent nodes, grand-parent nodes, great-grand-parent nodes, and so forth.

In general, there are two types of tree hierarchies, a common hierarchy and an inclusive hierarchy. In a common hierarchy, a category is solely an hierarchy organizational element (category) and is not also an item/object that is organized by the common hierarchy. For example, a filesystem is a common hierarchy that organizes and categorizes a plurality of files (items) of a computer via a plurality of folders (categories). Each folder in the filesystem is only an hierarchy organizational element (category) and is not an actual file (item/object) of the computer. As another example, a vehicle inventory is a common hierarchy that organizes and categorizes a plurality of vehicles (items) of a car dealership via a plurality of vehicle classifications (categories). Each vehicle classification (such as truck, SUV, sedan, etc.) in the vehicle inventory is only an hierarchy organizational element (category) and is not also an actual vehicle (item/object) of the car dealership.

In contrast, an inclusive hierarchy is a tree hierarchy whereby a category is both an hierarchy organizational element and an item/object that is organized by the inclusive hierarchy. For example, a company reporting structure is an inclusive hierarchy that organizes and categorizes a plurality of employees (items) of a company via a plurality of team managers (categories). Here, the managers are both categories and items (employees) of the company. The company reporting structure represents the reporting structure within the company and specifies which employees report to which managers, who in turn can report to an above manager, and so forth. As used herein, a manager (category) has one or more reportees (one or more child nodes), each reportee being an employee of the company that reports to the manager. A reportee can also be a manager (category) also having one or more reportees (one or more child nodes) or can be a non-manager. A non-manager is an item (leaf node) that has no reportees (no child nodes). In this type of hierarchy, each manager (category) is both a hierarchy organizational element and also an employee (item) of the company.

As another example of an inclusive hierarchy, an electronic connection arrangement is an inclusive hierarchy that organizes and categorizes a plurality of electronic components (items) of an electronic product via a plurality of electronic assemblies (categories). The electronic connection arrangement represents the connection structure within the electronic product and specifies which electronic components are connected to which electronic assemblies, which in turn can be connected to an above electronic assembly, and so forth. In this type of hierarchy, each electronic assembly (category) is both a hierarchy organizational element and also an electronic component (item) of the electronic product. As another example of an inclusive hierarchy, a software connection arrangement is an inclusive hierarchy that organizes and categorizes a plurality of software components (items) of a software application via a plurality of software modules (categories). The software connection arrangement represents the connection structure within the software application and specifies which software components are connected to which software modules, which in turn can be connected to an above software module, and so forth. In this type of hierarchy, each software module (category) is both a hierarchy organizational element and also a software component (item) of the software application.

A tree hierarchy, whether a common hierarchy or an inclusive hierarchy, can be visually represented by a conventional treemap that displays the tree hierarchy as a plurality of nested boxes/containers that represent the plurality of nodes of the tree hierarchy. A box of the treemap can represent a parent node (category) or a leaf node (item) of the tree hierarchy. The size of each box representing a leaf node in the treemap is equal to the smallest sized box in the treemap. In contrast, the size of a particular box representing a particular parent node is determined based on a total number of descendant nodes of the particular parent node that are leaf nodes (items), but the size of a particular box is not determined based on a number of descendant nodes of the particular parent node that are parent nodes (categories). Thus, in a conventional treemap, the number of descendent items (leaf nodes) included in a particular parent node is used to determine the box size for the particular parent node, whereas the number of descendent categories (parent nodes) included in the particular parent node is not relevant in determining the box size for the particular parent node. In general, a parent node having a larger number of leaf nodes (items) will have a larger box size that another parent node having a smaller number of leaf nodes (items).

A drawback of a conventional treemap when representing a common hierarchy is that the conventional treemap does not accurately represent the hierarchical structure of the common hierarchy. For example, a first box representing a first parent node that includes no descendent nodes that are parent nodes (categories) and one child node that is a leaf node (item) will have the same computed size as a second box representing a second parent node that includes multiple hierarchy levels/generations of descendent nodes that are parent nodes (categories) that end in one descendent node that is a leaf node (item). For example, a conventional treemap can be generated for a filesystem that is a common hierarchy that organizes and categorizes a plurality of files (items) of a computer via a plurality of folders (categories). Each folder in the filesystem is only an hierarchy organizational element and is not an actual file (item/object) of the computer. A first box representing a first folder that includes no descendent folders (categories) and one file (item) will have the same computed size as a second box representing a second folder that includes three levels of descendent folders (categories) that end in one file (item). The same sizes of the first box and the second box displayed in a conventional treemap can be misleading and does not accurately reflect the substantial differences in hierarchical levels of categories included in the first box and the second box and does not allow for accurate visual comparison of the different number of hierarchical levels of categories between the first box and the second box as the boxes are the same size.

A drawback of a conventional treemap when representing an inclusive hierarchy is that the sizes of the boxes in the conventional treemap does not accurately represent the number of items associated with each of the boxes in the conventional treemap. As discussed above, in an inclusive hierarchy, each category is both an hierarchy organizational element and an item of the inclusive hierarchy. However, in a conventional treemap, the size of a particular box representing a particular parent node is not computed based on a number of descendent nodes that are parent nodes (categories) included under the particular parent node. As such, a first box representing a first parent node that includes no descendent nodes that are parent nodes (categories) and one leaf node (item) will have the same computed size as a second box representing a second parent node that includes multiple hierarchy levels/generations of descendent nodes that are parent nodes (categories) that end in one descendent node that is a leaf node (item). Thus, the same sizes of the first box and the second box can be misleading to the user as the same sizes of the first box and the second box does not accurately reflect the differences in the number of items associated with the first box compared to the second box.

For example, a conventional treemap can be generated for a company reporting structure that is an inclusive hierarchy that organizes and categorizes a plurality of employees (items) of a company via a plurality of team managers (categories). In this type of hierarchy, each manager (category) is both a hierarchy organizational element and also an employee (item) of the company. In a conventional treemap, a first box representing a first manager that has a single reportee (item) will have a same size as a second box representing a second manager that has a first reportee that is a manager (category), who in turn has a second reportee (item) that is a non-manager. Although the first manager includes a total of one reportee and the second manager includes a total of two reportees, the first and second boxes will have the same computed size in the conventional treemap, which is misleading as the box sizes do not accurately represent the different number of reportees associated with the first and second boxes and does not allow for accurate visual comparison of team sizes within the company.

### Category-Counted Treemap Displayed Within a Treemap UI

The disclosed techniques described herein generate and display a category-counted treemap that represents a tree hierarchy that solves the above disadvantages of conventional techniques when generating and displaying a conventional treemap that represents a tree hierarchy. The disclosed techniques for generating and displaying a category-counted treemap can be applied to both common hierarchies and inclusive hierarchies. In this regard, the treemap application 120 can receive and process a tree hierarchy 150 to generate a category-counted treemap representing the tree hierarchy 150, and display the generated category-counted treemap in the treemap UI 130. The treemap application 120 can do so whether the tree hierarchy 150 includes a common hierarchy or an inclusive hierarchy.

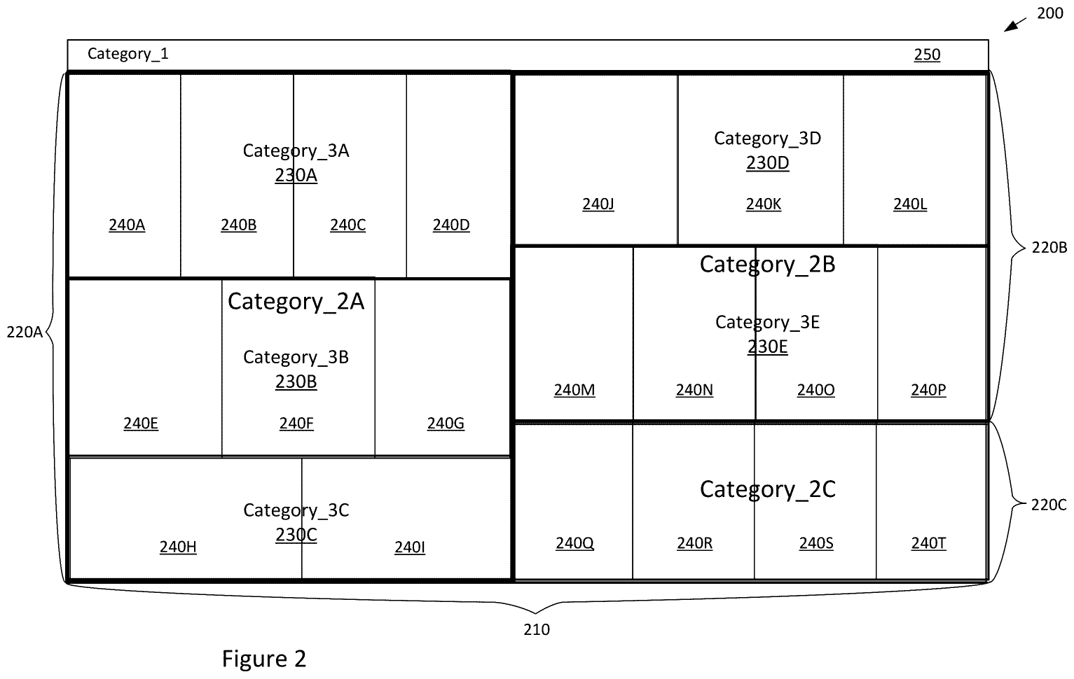

FIG. 2 is a screenshot of a category-counted treemap 200 displayed in the treemap UI 130 of FIG. 1, according to various embodiments. As shown, the category-counted treemap 200 visually represents a tree hierarchy 150 as a plurality of nested boxes that represent the plurality of nodes of the tree hierarchy 150. Each box of the category-counted treemap 200 can represent a parent node (category) or leaf node (item) of the tree hierarchy 150. The boxes of the category-counted treemap 200 are nested to different hierarchical levels of categories. In general, each branch of the tree hierarchy 150 is assigned a particular box, which is then tiled with smaller boxes representing sub-branches of the tree hierarchy 150, until a smallest box representing a leaf node (item) of the tree hierarchy 150 is reached.

As shown, the category-counted treemap 200 displays boxes representing parent nodes (categories) at various hierarchy levels, including a category_1 box 210, various category_2 boxes 220 (such as 220A, 220B, 220C), and various category_3 boxes 230 (such as 230A, 230B, 230C, etc.). The category_1 box 210 represents a category_1 node (root node) for a category at a first top hierarchy level of the tree hierarchy 150. Each category_2 box 220 represents a category_2 node for a category at a second hierarchy level of the tree hierarchy 150, which is a direct child node of the category_1 node (root node). Each category_3 box 230 represents a category_3 node for a category at a third hierarchy level of the tree hierarchy 150, which is a direct child node of a category_2 node. As shown, the category-counted treemap 200 also displays various item boxes 240 (such as 240A, 240B, 240C, etc.) representing leaf nodes (items) of the tree hierarchy 150. For the sake of clarity, only three hierarchy levels of categories are shown in FIG. 2. However, in other embodiments, the category-counted treemap 200 can include a greater number of hierarchy levels of categories.

In some embodiments, the size of each item box 240 representing a leaf node in the category-counted treemap 200 is equal to the smallest sized box in the category- counted treemap 200. In some embodiments, the treemap application 120 computes a size of each box 210-230 representing a particular parent node based on a total number of descendant nodes of the particular parent node that are either parent nodes (categories) or leaf nodes (items). In other words, the treemap application 120 computes a size of each box 210-230 representing a particular parent node based on the total number of descendant nodes of the particular parent node, regardless of whether the descendant node is a parent node or leaf node. Thus, the treemap application 120 computes a size of each box 210-230 representing a particular parent node based on a total number of descendant categories and items included in the particular parent node and associated with the box. In general, the size of a box representing a particular parent node is proportional to the total number of descendent categories and items included in the particular parent node and associated with the box. Thus, a box representing a parent node that includes a larger number of descendent categories and items appears larger in the category-counted treemap 200 than another box representing another parent node that includes a smaller number of descendent categories and items. In this manner, the treemap application 120 counts each descendent category of the particular parent node as a descendent item when computing the box size for the particular parent node in the category-counted treemap 200.

As shown, the category_1 box 210 includes three descendent categories at the second hierarchy level represented by the category_2 boxes 220 comprising the category_2A box 220A, category_2B box 220B, and category_2C box 220C. The category_2A box 220A includes three descendent categories at the third hierarchy level represented by the category_3 boxes 230 comprising the category_3A box 230A, category_3B box 230B, and category_3C box 230C. The category_3A box 230A includes four descendent items represented by item boxes 240A, 240B, 240C, and 240D. Thus, the size of the category_3A box 230A is computed to be based on and proportional to four items. The category_3B box 230B includes three descendent items represented by item boxes 240E, 240F, and 240G. Thus, the size of the category_3B box 230B is computed to be based on and proportional to three items. The category_3C box 230C includes two descendent items represented by item boxes 240H and 240I. Thus, the size of the category_3C box 230C is computed to be based on and proportional to two items. The size of the category_2A box 220A is computed based on a total number of all descendent categories and items included in the category_2A box 220A. Thus, the size of the category_2A box 220A is computed based on a total of three descendent categories and nine descendent items, for a total of twelve items, whereby the categories are counted as items for determining box sizes. Thus, the size of the category_2A box 220A is computed to be based on and proportional to twelve items.

As shown, the category_2B box 220B includes two descendent categories at the third hierarchy level represented by the category_3 boxes 230 comprising the category_3D box 230D and category_3E box 230E. The category_3D box 230D includes three descendent items represented by item boxes 240J, 240K, and 240L. Thus, the size of the category_3D box 230D is computed to be based on and proportional to three items. The category_3E box 230E includes four descendent items represented by item boxes 240M, 240N, 2400, and 240P. Thus, the size of the category_3E box 230E is computed to be based on and proportional to four items. The size of the category_2B box 220B is computed based on a total number of all descendent categories and items included in the category_2B box 220B. Thus, the size of the category_2B box 220B is computed based on a total of two descendent categories and seven descendent items, for a total of nine items, whereby the categories are counted as items for determining box sizes. Thus, the size of the category_2B box 220B is computed to be based on and proportional to nine items. As shown, the category_2C box 220C includes four descendent items represented by the item boxes 240Q, 240R, 240S, and 240T. Thus, the size of the category_2C box 220C is computed to be based on and proportional to four items.

Finally, the size of the category_1 box 210 is computed based on a total number of all descendent categories and items included in the category_1 box 210. Thus, the size of the category_1 box 210 is computed based on a total of eight descendent categories (three categories at the second hierarchy level and five categories at the third hierarchy level) and twenty descendent items, for a total of twenty-eight items, whereby the categories are counted as items for determining box sizes. Thus, the size of the category_1 box 210 is computed to be based on and proportional to twenty-eight items.

If the tree hierarchy 150 is a common hierarchy, the category-counted treemap 200 more accurately represents the hierarchical structure of the common hierarchy than a conventional treemap. For example, in the category-counted treemap 200, a first box representing a first parent node that includes no descendent categories and one descendent item will have a smaller computed size than a second box representing a second parent node that includes multiple descendent categories that end in one descendent item. The smaller size of the first box compared to the second box displayed in the category-counted treemap 200 visually indicates to the user that the second box is associated with a larger number of hierarchical levels of categories than the first box, thus providing the user a more complete and accurate view of the hierarchical structure of the common hierarchy relative to a conventional treemap.

If the tree hierarchy 150 is an inclusive hierarchy, the category-counted treemap 200 more accurately represents the number of items associated with each box of the category-counted treemap 200. For example, a first box representing a first parent node that includes no descendent categories and one descendent item will have a smaller computed size than a second box representing a second parent node that includes multiple descendent categories that end in one descendent item. The smaller size of the first box compared to the second box displayed in the category-counted treemap visually indicates to the user that the second box includes a larger number of descendent items (which includes descendent categories and items for inclusive hierarchies) than the first box, thus providing the user a more accurate view of the number of items associated with each of box in the category-counted treemap 200 relative to a conventional treemap.

For example, a category-counted treemap 200 can be generated for a company reporting structure that is an inclusive hierarchy that organizes and categorizes a plurality of employees (items) of a company via a plurality of team managers (categories). Each person/employee in the company is represented by a corresponding box in the category-counted treemap 200. The category_1 box 210 can represent the CEO of the company, which every employee of the company reports to either directly or indirectly. Each category_2 box 220 can represent a top manager of the company that directly reports to the CEO and has one or more reportees. Each category_3 box 230 can represent a middle manager of the company that each directly reports to a particular top manager and has one or more reportees. Each item box 240 can represent a non-manager employee of the company that directly reports to a particular middle manager. The non-manager employee does not have any reportees.

Advantageously, the category-counted treemap 200 visually illustrates valuable insights into the company, such as the reporting structure for the company that specifies which employees reports to which managers, how particular employees are related within the company, the overall size of the company, and the like. In some embodiments, a particular category hierarchy level corresponds to departments of the company. For example, the category_2 boxes 220 can represent top managers for different departments of the company, such as finance, marketing, research, and the like. In these embodiments, the category-counted treemap 200 visually illustrates, via the different box sizes, the sizes of each department relative to each other. In general, the category-counted treemap 200 visually illustrates, via the different box sizes, the sizes of different teams led by different managers relative to each other.

In some embodiments, the box lines defining each box are thicker for boxes representing parent nodes (categories) towards the top hierarchy level of the tree hierarchy 150. In these embodiments, the box lines will be thicker for the category_1 box 210 compared to the category_2 boxes 220, which will have thicker box lines compared to the category_3 boxes 230, whereby the item boxes 240 will have the thinnest box lines.

In some embodiments, the category-counted treemap 200 displays within a box a name/identifier of a category or item corresponding to the box. For example, for each category_2 box 220 that represents a category_2 node, the category-counted treemap 200 can display the name/identifier of the category corresponding to the category_2 box 220 and the category_2 node in the tree hierarchy 150, such as “category_2A,” “category_2B,” “category_2C,” etc. The category-counted treemap 200 can also display the name/identifier of the category corresponding to the category_3 box 230 and the category_3 node in the tree hierarchy 150, such as “category_3A,” “category_3B,” “category_3C,” etc. For example, for a company reporting structure, the category-counted treemap 200 can display within the category_2 boxes 220 the names of the top managers corresponding to the category_2 boxes 220 and the category_2 nodes in the tree hierarchy 150 and display within the category_3 boxes 230 the names of the middle managers corresponding to the category_3 boxes 230 and the category_3 nodes in the tree hierarchy 150. In some embodiments, to avoid visual clutter, the category-counted treemap 200 only displays the name/identifier of the category within the corresponding box up to a predetermined hierarchy level of the tree hierarchy 150, and does not display the name/identifier of the category within the corresponding box beyond the predetermined hierarchy level of the tree hierarchy 150. For example, the category-counted treemap 200 can only display the names of the categories corresponding to the second and third hierarchy levels (the category_2 boxes 220 and category_3 boxes 230), and not display the names of the categories corresponding to hierarchy levels above the third hierarchy levels, such as category_4 boxes and category_5 boxes (not shown) and item boxes 240.

As shown, the category-counted treemap 200 also includes a navigation bar 250 that specifies a current portion of the category-counted treemap 200 that is currently displayed. In some embodiments, the navigation bar 250 specifies a node path associated with the current portion of the category-counted treemap 200 that is currently being displayed in the treemap UI 130. The node path can specify one or more categories or items that are traversed in the tree hierarchy 150 to reach the current portion of the category-counted treemap 200 that is currently being displayed in the treemap UI 130. In the example of FIG. 2, the navigation bar 250 specifies the name of the category_1 box 210 (“category_1”) since the category_1 box 210 is the current view being displayed in the treemap UI 130.

In some embodiments, each box displayed in the category-counted treemap 200 is selectable by the user for navigating the category-counted treemap 200. In these embodiments, in response to a selection of a particular box (such as receiving a click within the box or on the displayed name of the box), the treemap application 120 generates a zoomed-in view of the selected box so the user can view the details of the selected box. The navigation bar 250 can be updated accordingly based on the selected box. In some embodiments, the treemap UI 130 only displays the zoomed-in view of the selected box within the treemap 200 in response to the user selection of the selected box.

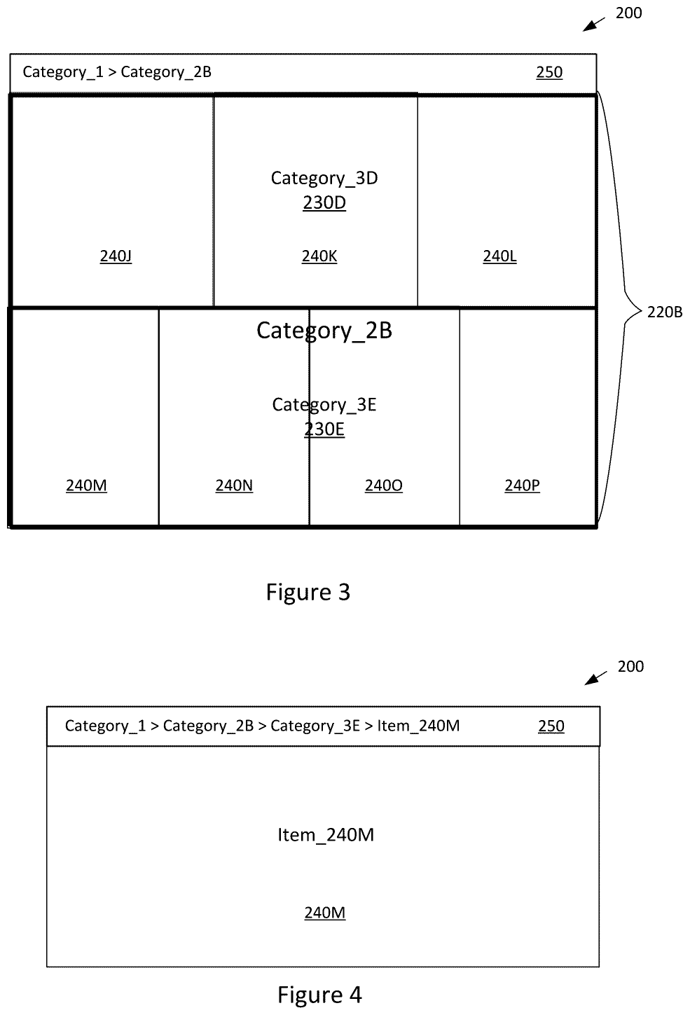

FIG. 3 is a screenshot of a first selected box of the category-counted treemap of FIG. 2, according to various embodiments. As shown, the user has selected the category_2B box 220B of the category-counted treemap 200, which causes the treemap application 120 to perform a zoom-in operation focused on the selected category_2B box 220B so the user can closer view details of selected category_2B box 220B. In some embodiments, the treemap UI 130 only displays the zoomed-in view of the selected category_2B box 220B within the treemap 200 in response to the user selection of the selected box. As shown, the navigation bar 250 can be updated accordingly based on the selected box, whereby the navigation bar 250 now specifies the name of the category_1 box 210 and the name of the category_2B box 220B (“Category_1>Category_2B”) as the node path to the current view being displayed in the treemap UI 130.

FIG. 4 is a screenshot of a second selected box of the category-counted treemap of FIG. 2, according to various embodiments. As shown, the user has selected the item box 240M from the category_3E box 230E of the category_2B box 220B shown in FIG. 3, which causes the treemap application 120 to perform a zoom-in operation focused on the selected item box 240M. When zoomed in on the selected item box 240M, the category-counted treemap 200 can then display a name corresponding to an item associated with the item box 240M, such as “Item_240M.” In some embodiments, the treemap UI 130 only displays the zoomed-in view of the selected item box 240M within the treemap 200 in response to the user selection of the selected box. As shown, the navigation bar 250 can be updated accordingly based on the selected box, whereby the navigation bar 250 now specifies the name of the category_1 box 210, the name of the category_2B box 220B, the name of the category_3E box 230E, and the name of the selected item box 240M (“Category_1>Category_2B>Category_3E>Item_240M”) as the node path to the current view being displayed in the treemap UI 130.

### Offset Nesting for Single Direct Child Nodes

In some embodiments, the treemap application 120 also implements an offset nesting technique when generating a category-counted treemap 200 for a tree hierarchy 150 when a parent node of the tree hierarchy 150 includes only a single direct child node (which in turn can also be a parent node or a leaf node). In this situation, when implementing conventional techniques for generating and displaying the boxes of the treemap for representing the nodes of the tree hierarchy 150, a child box representing a single direct child node of a parent node is nested inside a parent box representing the parent node so that the two boxes are completely overlapped and appear as a single box, which is misleading as there are actually two boxes representing two different nodes of the tree hierarchy 150.

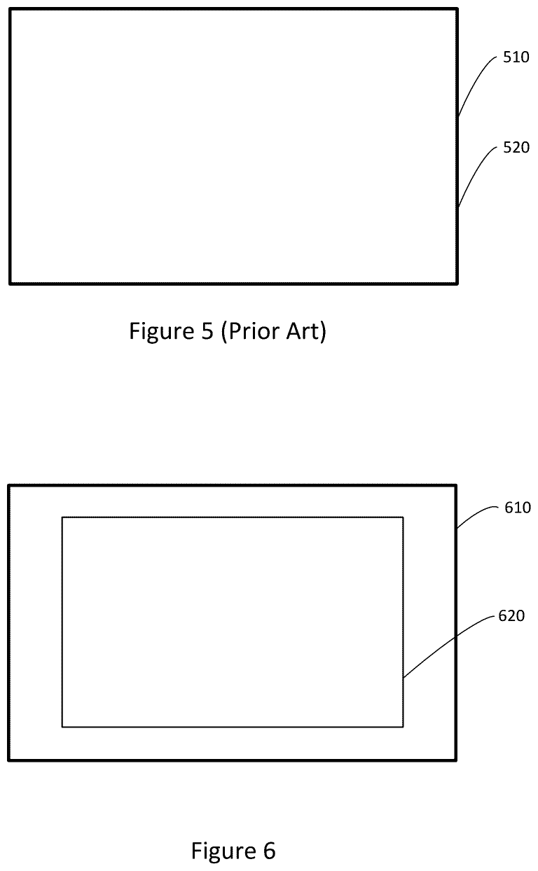

FIG. 5 illustrates a treemap representation of a parent node that includes a single direct child node, in accordance with prior approaches. A first box (parent box) 510 is generated for the parent node and a second box (child box) 520 is generated for the single direct child node of the parent node. In conventional techniques, the child box 520 is nested inside the parent box 510 so that the borders of the parent box 510 and the child box 520 completely overlap, giving the appearance that only a single box is being displayed. Displaying the parent box 510 and the child box 520 as a single box is misleading and inaccurate as there are actually two separate boxes being displayed to represent two different nodes of the tree hierarchy 150.

To address the drawbacks of the above prior approach, the treemap application 120 implements an offset nesting technique when a parent node includes only a single direct child node to ensure that the parent box and the child box appears as two separate and distinct boxes. FIG. 6 illustrates an offset nesting technique applied to a first node scenario of a tree hierarchy, according to various embodiments. In the first node scenario, a parent node includes a single direct child node in the tree hierarchy 150. A first box (parent box) 610 is generated for the parent node and a second box (child box) 620 is generated for the single direct child node of the parent node. In some embodiments, the child box 620 is nested inside the parent box 610 in an offset manner so that the parent box 610 and the child box 620 appears as two separate and distinct boxes when displayed in the category-counted treemap 200.

In some embodiments, the area of the child box 620 is a sub-set of the area of the parent box 610, whereby the area of the child box 620 is smaller than the parent box 610 by a predetermined percentage or ratio. In some embodiments, a border of the child box 620 does not completely overlap a border of the parent box 610. In some embodiments, no portion of a border of the child box 620 overlaps any portion of a border of the parent box 610. In some embodiments, a border of the child box 620 is completely enclosed inside a border of the parent box 610, wherein a predetermined gap distance exists between the border of the child box 620 and the border of the parent box 610. The predetermined gap distance can be specified, for example, in pixel values or percentage values. In some embodiments, a gap portion is displayed between the border of the child box 620 and the border of the parent box 610, wherein the gap portion has a predetermined width/thickness that can be specified, for example, in pixel values or percentage values.

In other embodiments, any technique can be used to ensure that the child box 620 is nested inside the parent box 610 in an offset manner so that the parent box 610 and the child box 620 appears as two separate and distinct boxes when displayed in the category-counted treemap 200. Advantageously, displaying the parent box 610 and the child box 620 as two separate boxes is accurate as there are actually two separate boxes being displayed to represent two different nodes of the tree hierarchy 150, thus addressing the drawbacks of the prior approach illustrated in FIG. 5.

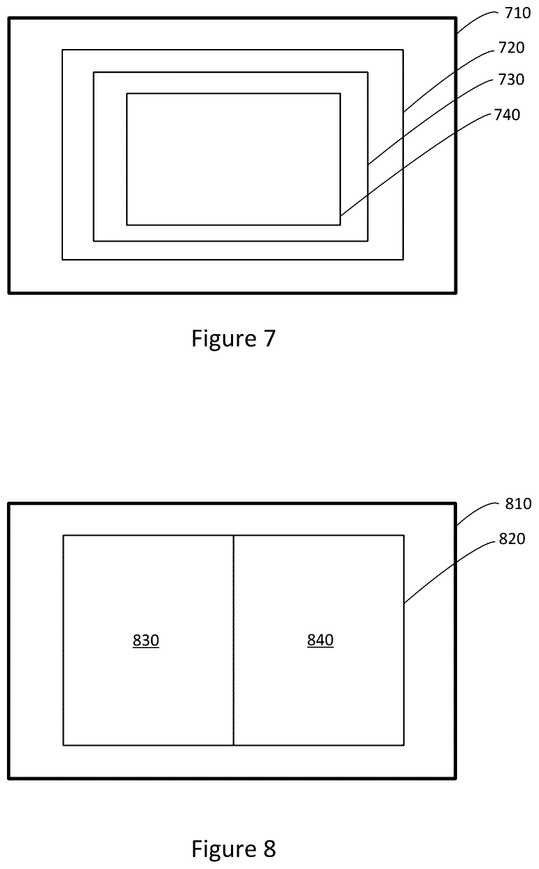

The offset nesting technique can also be applied repeatedly for scenarios where there are multiple levels/generations of parent nodes with single direct child nodes. FIG. 7 illustrates an offset nesting technique applied to a second node scenario of a tree hierarchy, according to various embodiments. In the second node scenario, a parent node includes a single direct child node, which includes single direct child node, which includes a single direct child node in the tree hierarchy 150. A first box (parent box) 710 is generated for the parent node, a second box (first child box) 720 is generated for a first child node comprising a single direct child node of the parent node, a third box (second child box) 730 is generated for a second child node comprising a single direct child node of the first child node, and a fourth box (third child box) 740 is generated for a third child node comprising a single direct child node of the second child node. As shown, the first child box 720 is nested inside the parent box 710 in an offset manner so that the parent box 710 and the first child box 720 appears as two separate and distinct boxes. The second child box 730 is nested inside the first child box 720 in an offset manner so that the first child box 720 and the second child box 730 appears as two separate and distinct boxes. The third child box 740 is nested inside the second child box 730 in an offset manner so that the second child box 730 and the third child box 740 appears as two separate and distinct boxes.

The offset nesting technique can also be applied when the single direct child node of the parent node is also a parent node of two or more direct child nodes. FIG. 8 illustrates an offset nesting technique applied to a third node scenario of a tree hierarchy, according to various embodiments. In the third node scenario, a parent node includes a single direct child node, which includes two direct child nodes in the tree hierarchy 150. A first box (parent box) 810 is generated for the parent node, a second box (first child box) 820 is generated for a first child node comprising a single direct child node of the parent node, a third box (second child box) 830 is generated for a second child node comprising a direct child node of the first child node, and a fourth box (third child box) 840 is generated for a third child node comprising a direct child node of the first child node. As shown, the first child box 820 is nested inside the parent box 810 in an offset manner so that the parent box 810 and the first child box 820 appears as two separate and distinct boxes. For the second child box 830 and the third child box 840, the offset nesting techniques do not need to be applied as these nodes are multiple direct child nodes of the first child box 820. Thus, the second child box 830 and the third child box 840 can be simply nested inside the first child box 820.

### Search Function and Information Cards

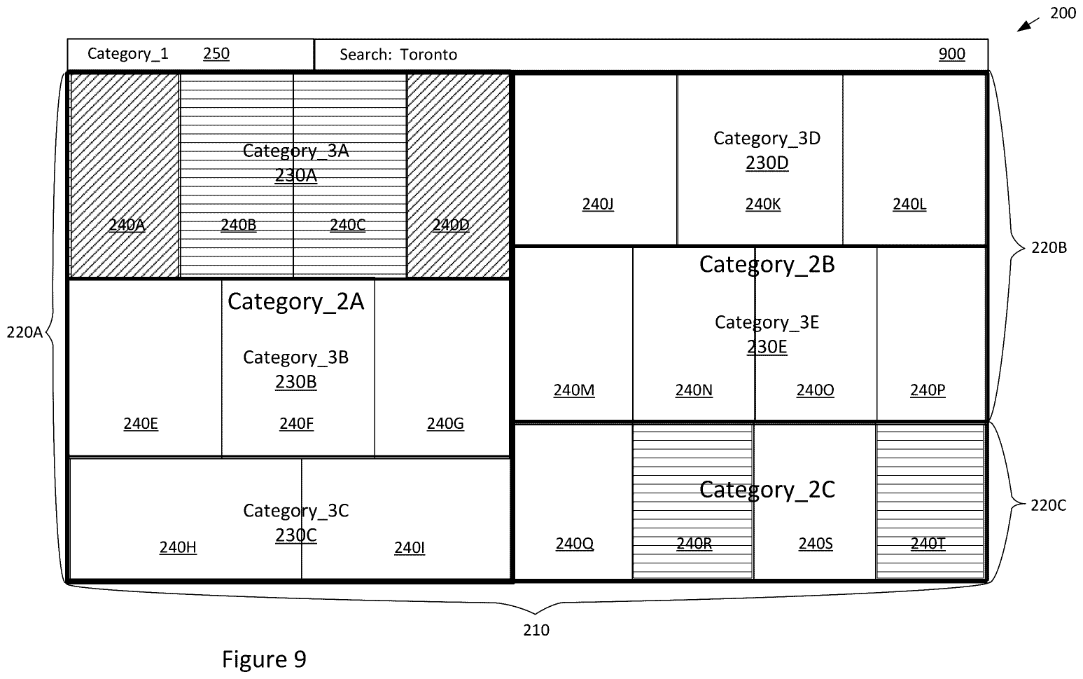

In some embodiments, the treemap application 120 also enables a search function for searching nodes of the tree hierarchy 150, and then displaying search results via the category-counted treemap 200 in the treemap UI 130. FIG. 9 is a screenshot of a search function implemented via the category-counted treemap, according to various embodiments. As shown, the category-counted treemap 200 includes a search bar 900 for receiving user search inputs that include, for example, search keywords. Upon receiving a search input via the search bar 900, the treemap application 120 searches the locally stored tree hierarchy 150 for any nodes matching or related to the search input to generate a set of matching nodes. A matching node can be a category (parent node) or an item (leaf node) within the tree hierarchy 150. The treemap application 120 then identifies a set of matching boxes within the category-counted treemap 200 corresponding to the set of matching nodes. Each matching box in the set of matching boxes corresponds to and represents a particular matching node in the set of matching nodes. In the example of FIG. 9, the set of matching boxes includes the category_3A box 230A and item boxes 240A, 240D, 240R, and 240T, which are visually highlighted.

The treemap application 120 then visually highlights the set of matching boxes within the category-counted treemap 200 by changing the visual appearance of the set of matching boxes to be different in some manner from the visual appearance of the remaining boxes of the category-counted treemap 200. For example, the set of matching boxes can be highlighted using a different shade, tone, tint, or color than the remaining boxes of the category-counted treemap 200. For example, the set of matching boxes can be highlighted using a hatching or etching pattern to differentiate the matching boxes from the remaining boxes of the category-counted treemap 200. For example, the set of matching boxes can be highlighted using a darker or different color border than the remaining boxes of the category-counted treemap 200. For example, the set of matching boxes can be highlighted by dimming the remaining boxes of the category-counted treemap 200. In other embodiments, the set of matching boxes are visually highlighted in a different manner to differentiate their visual appearance relative to the remaining boxes of the category-counted treemap 200.

In some embodiments, each matching box is displayed as a semi-transparent box with a same predetermined darkness in a same predetermined color. A matching box can then be stacked on top of one or more other matching boxes to visually indicate that the matching boxes correspond to nodes at different hierarchy levels of the tree hierarchy 150. This is useful, for example, when a first matching box is a parent node (category) that includes a second matching box that is a leaf node (item) and a third non-matching box that is a leaf node (item). The first matching box and the second matching box can each be displayed as a semi-transparent box with the same predetermined darkness and the same predetermined color. Thus, when stacked together, the second matching box will appear darker than the third non-matching box, which indicates to the user that the first matching box and the second matching box matches the search input, but that the third non-matching box does not match the search input.

For example, in FIG. 9, the set of matching boxes include the category_3A box 230A and item boxes 240A and 240D. The category_3A box 230A is a category that includes item boxes 240A and 240D which match the search input and also includes item boxes 240B and 240C which do not match the search input. The category_3A box 230A is displayed as a semi-transparent box with the predetermined darkness and the predetermined color, and then the item boxes 240A and 240D are displayed as a semi-transparent box with the same predetermined darkness and the same predetermined color. Thus, when stacked on top of each other, the item boxes 240A and 240D appear darker than the category_3A box 230A, which indicates to the user that the category_3A box 230A and item boxes 240A and 240D all match the search input, but that item boxes 240B and 240C do not match the search input.

For example, for a tree hierarchy 150 comprising a company reporting structure, the received search input specifies a search for employees that work in Toronto. The category_3A box 230A can represent a middle manager that works in Toronto who has two reportees represented by item boxes 240A and 240D that also work in Toronto, and two reportees represented by item boxes 240B and 240C that do not work in Toronto. The category_2C box 220C can represent a middle manager that does not work in Toronto but who has two reportees represented by item boxes 240R and 240T that work in Toronto, and two reportees represented by item boxes 240Q and 240S that do not work in Toronto. Thus, the user can easily see how many and which employees work in Toronto via the search function in the category-counted treemap 200.

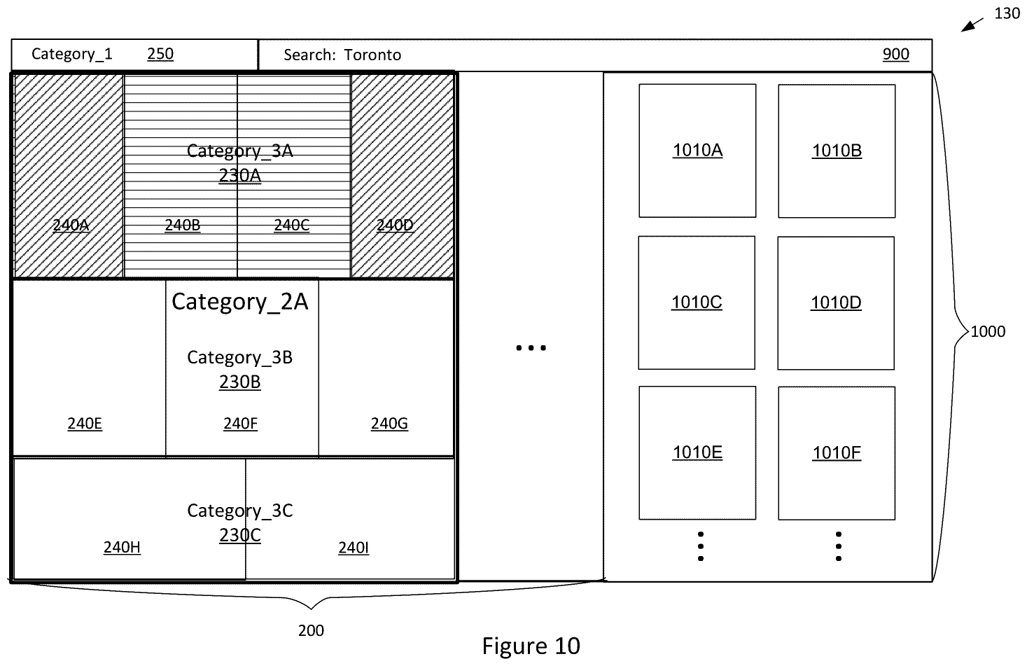

In some embodiments, the treemap application 120 also generates and displays an information card section within the treemap UI 130. The information card section displays a set of information cards that correspond to the set of boxes of the category-counted treemap 200. FIG. 10 is a screenshot of the treemap UI that includes an information card section and the category-counted treemap, according to various embodiments. As shown, the treemap UI 130 displays an information card section 1000 adjacent to the category-counted treemap 200. The information card section 1000 displays a set of information cards 1010 (such as 1010A, 1010B, 1010C, etc.) that correspond to a set of boxes in the category-counted treemap 200, which in turn corresponds to a set of nodes of the tree hierarchy 150. Each information card 1010 corresponds to a particular box in the category-counted treemap 200, which in turn corresponds to a particular node of the tree hierarchy 150, whereby the particular node can be a parent node (category) or a leaf node (item).

The information card 1010 can display various information or metadata of the corresponding node that can be derived from the tree hierarchy 150, such as a name/identifier for the category or item, basic descriptive characteristics of the category or item, parent-child relationships with other categories or items in the tree hierarchy 150, and the like. The type of information or metadata displayed in the information card 1010 will vary based on the type of tree hierarchy 150. For example, for a tree hierarchy 150 that is a filesystem, an information card 1010 can include information such as a folder or file name, size of the folder or file, date of creation of the folder or file, access permissions for the folder or file, and the like. For example, for a tree hierarchy 150 that is a company reporting structure, an information card 1010 can include employee information such as a name, title, work location, a headshot image, and the like.

In some embodiments, the treemap UI 130 displays a set of information cards 1010 that correspond to the set of matching boxes and the set of matching nodes that match a search input, as discussed in relation to FIG. 9. Referring back to the example of FIG. 9, the set of information cards 1010 can include information cards 1010 corresponding to the matching boxes category_3A box 230A and item boxes 240A, 240D, 240R, and 240T. For example, for a company reporting structure, the set of information cards 1010 can include information cards for the employees that work in Toronto (the search input). In some embodiments, the treemap UI 130 displays a default set of information cards 1010, such as information cards 1010 that correspond to nodes of one or more particular hierarchy levels. For example, the default set of information cards 1010 can include information cards 1010 that correspond to the category_1 node and category_2 nodes of the tree hierarchy 150.

In some embodiments, upon receiving a user selection of a particular box within the category-counted treemap 200, the treemap UI 130 displays an information card 1010 that corresponds to the selected box in the information card section 1000. For example, if a user selection of the item box 240H within the category-counted treemap 200 is received, the treemap UI 130 displays an information card 1010 corresponding to the selected item box 240H in the information card section 1000. In other embodiments, the treemap UI 130 can display the information card 1010 corresponding to the selected box adjacent to the selected box within the category-counted treemap 200, rather than being displayed in the information card section 1000.

In some embodiments, upon receiving a user selection of a particular information card 1010 in the information card section 1000 (such as a cursor hovering over the particular information card 1010), the treemap UI 130 visually highlights the box within the category-counted treemap 200 that corresponds to the selected information card 1010. In some embodiments, upon receiving a user selection of a particular information card 1010 in the information card section 1000 (such as receiving a click on the particular information card 1010), the treemap UI 130 performs a zoom-in operation within the category-counted treemap 200 that is focused on the box that corresponds to the selected information card 1010. The zoom-in operation is discussed above in relation to FIGS. 3-4.

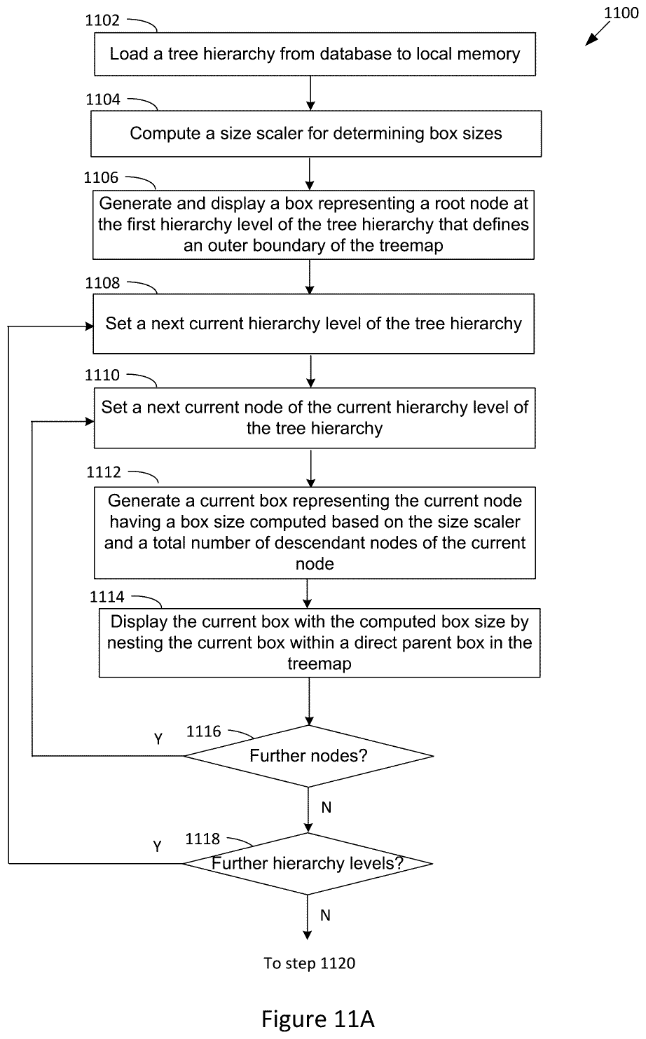

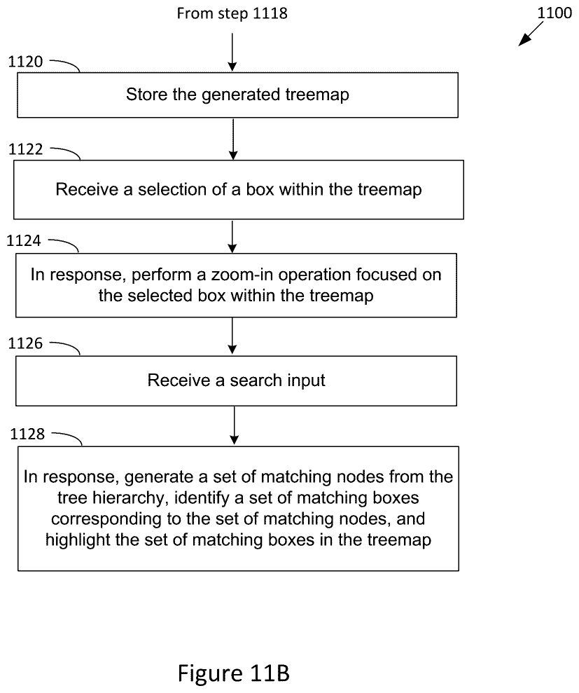

FIGS. 11A-B set forth a flow diagram of method steps for generating and displaying a category-counted treemap representing a tree hierarchy, according to various embodiments. Although the method steps are described in conjunction with the systems of FIGS. 1-10, persons skilled in the art will understand that the method steps can be performed in any order by any system. In some embodiments, the method 1100 can be performed by the treemap application 120 that generates and displays the treemap UI 130, which includes the category-counted treemap 200 and an information card section 1000.

The method 1100 begins when the treemap application 120 loads (at step 1102) a particular tree hierarchy 150 from the tree-hierarchy database 180 to local memory 104 in response to receiving, via the treemap UI 130, a user selection to view a treemap representing the particular tree hierarchy 150. The tree-hierarchy database 180 stores various hierarchical datasets that specify various tree hierarchies that can be loaded to the computer system 106 for processing. A hierarchical dataset for a tree hierarchy 150 can include various information or metadata for each parent node (category) and leaf node (item) of the tree hierarchy 150, such as a name/identifier for the category or item, basic descriptive characteristics of the category or item, parent-child relationships with other categories or items in the tree hierarchy 150, and the like. A tree hierarchy 150 can be a common hierarchy or an inclusive hierarchy.

At step 1104, the treemap application 120 computes a size scaler based on a total display area and a total number of nodes included in the tree hierarchy 150. For example, the treemap application 120 can traverse the tree hierarchy 150 to determine the total number of nodes included in the tree hierarchy 150. The total display area can comprise a total pixel area that is usable for displaying the category-counted treemap 200. The total display area (height×width) can be represented, for example, in pixel values. The size scaler can be determined experimentally for best results based on a ratio of the total display area and the total number of nodes. In general, the size scaler decreases in value as the total number of nodes increases since more boxes representing the nodes need to fit into the total display area. In general, the size scaler decreases in value as the display area decreases since there is less display area to fit the boxes representing the nodes of the tree hierarchy 150.

The size scaler is later used to determine the size of each box in the category-counted treemap 200. The size of a box can comprise an area of the box (height×width) that can be represented, for example, in pixel values or percentage values. The size scaler is used to determine the size of a particular box that represents a particular node in the tree hierarchy 150 based on total number descendant nodes of the particular node, including descendant parent nodes (categories) and descendant leaf nodes (items). Thus, the size of a particular box is computed based on the size scaler and the total number of descendant nodes (descendant categories and descendant items) included in the corresponding node. In this manner, the size of a particular box is based on and proportional to the total number of descendant categories and descendant items associated with the particular box.

At step 1106, the treemap application 120 generates and displays a category_1 box representing the category_1 node (root node) at the first hierarchy level of the tree hierarchy 150 in the treemap UI 130. The treemap application 120 does so by computing a size of the category_1 box by applying the size scaler to a total number of descendant nodes (descendant categories and descendant items) included in the corresponding category_1 node (such as size scaler x total number of descendant nodes) and display the category_1 box with the computed box size in the treemap UI 130. The category_1 box defines the outer boundary of the category-counted treemap 200.

At steps 1108-1118, the treemap application 120 then iterates through all the hierarchy levels of the tree hierarchy 150 to generate and display a box for each node of each hierarchy level of the tree hierarchy 150. At step 1108, the treemap application 120 sets a next current hierarchy level of the tree hierarchy 150. For example, in the first iteration a second hierarchy level of the tree hierarchy 150 is set as the current hierarchy level, in the second iteration a third hierarchy level of the tree hierarchy 150 is set as the current hierarchy level, and so forth until all hierarchy levels of the tree hierarchy 150 are processed. At step 1110, the treemap application 120 sets a next current node of the current hierarchy level of the tree hierarchy 150. For example, in the first iteration a first node of the current hierarchy level of the tree hierarchy 150 is set as the current node, in the second iteration a second node of the current hierarchy level of the tree hierarchy 150 is set as the current node, and so forth until all nodes of the current hierarchy level of the tree hierarchy 150 are processed.

At step 1112, the treemap application 120 generates a current box representing the current node at the current hierarchy level of the tree hierarchy 150. The treemap application 120 does so by computing a size of the current box by applying the size scaler to a total number of descendant nodes (descendant categories and descendant items) included in the corresponding current node (such as size scaler×total number of descendant nodes). At step 1114, the treemap application 120 then displays to the user the current box with the computed box size in the category-counted treemap 200 by nesting the current box within a direct parent box in the category-counted treemap 200 that represents a direct parent node of the current node in the tree hierarchy 150. If the current node is the only direct child node of the direct parent node, then the current box is nested within the direct parent box using the offset nesting technique.

At step 1116, the treemap application 120 determines if any further nodes in the current hierarchy level need to be processed. If so, the method 1100 returns to step 1110 whereby a next node of the current hierarchy level is processed. If not, the method 1100 continues to step 1118. At step 1118, the treemap application 120 determines if any further hierarchy levels of the tree hierarchy 150 need to be processed. If so, the method 1100 returns to step 1108 whereby a next hierarchy level of the tree hierarchy 200 is processed. If not, the method 1100 continues to step 1120.

At this point, all the hierarchy levels of the tree hierarchy 150 are processed and the completed category-counted treemap 200 has been generated and displayed in the treemap UI 130 to the user. Thus, at step 1120, the treemap application 120 stores the category-counted treemap 200, for example to local memory 104 and/or a database as a nested tree data structure. In other embodiments, other types of treemap layout algorithms can be used in steps 1108-1118, as long as the box sizes are based on the total number of all descendant nodes.

At step 1122, the treemap application 120 receives a user selection for a particular box within the category-counted treemap 200. At step 1124, in response to the selected box, the treemap application 120 performs a zoom-in operation focused on the selected box to display to the user a zoomed-in view of the particular box within the category-counted treemap 200. Optionally, the treemap application 120 can also display to the user an information card 1010 corresponding to the selected box within an information card section 1000 or within the category-counted treemap 200.

At step 1126, the treemap application 120 receives a user search input. At step 1128, in response to the search input, the treemap application 120 performs a search for nodes in the tree hierarchy 150 that match the search input to generate a set of matching nodes, identifies a set of matching boxes in the category-counted treemap 200 that correspond to the set of matching nodes, and visually highlights the set of matching boxes in the category-counted treemap 200. Optionally, the treemap application 120 can also display an information card 1010 corresponding to each matching box within the information card section 1000 adjacent to the category-counted treemap 200.

In sum, the disclosed techniques generate and display to the user a category-counted treemap that visually represents a tree hierarchy as a plurality of nested boxes that represent the plurality of nodes of the tree hierarchy. A box of the category-counted treemap can represent a parent node (category) or leaf node (item) of the tree hierarchy. The size of each box representing a particular parent node is determined based on a total number of descendant nodes of the particular parent node that are either parent nodes (categories) or leaf nodes (items). In this manner, the disclosed techniques count each descendent node of the particular parent node that is a parent node (categories) as an item when computing the box size for the particular parent node in the treemap. The disclosed techniques also include an offset nesting technique when a parent node of the tree hierarchy includes only a single direct child node (which in turn can also be a parent node or a leaf node), whereby the parent box and the child box appears as two separate and distinct boxes in the category-counted treemap.

At least one technical advantage of the disclosed techniques relative to the prior art is that the disclosed techniques generate and display category-counted treemaps that more accurately represent hierarchical datasets relative to conventional approaches. In particular, a category-counted treemap visually represents a tree hierarchy (hierarchical dataset) as a plurality of nested boxes that represent the plurality of nodes of the tree hierarchy. A box of the category-counted treemap can represent a parent node (category) or leaf node (item) of the tree hierarchy. The size of each box representing a particular parent node is determined based on a total number of descendant nodes of the particular parent node that are either parent nodes (categories) or leaf nodes (items). In this manner, the disclosed techniques count each descendent node of the particular parent node that is a parent node (categories) as an item when computing the box size for the particular parent node in the treemap.

As applied to a common hierarchy, the disclosed techniques generate and display a category-counted treemap that more accurately represents the hierarchical structure of the common hierarchy than a conventional treemap. For example, a first box representing a first parent node that includes one leaf node (item) will have a smaller computed size than a second box representing a second parent node that includes multiple hierarchy levels/generations of descendent nodes that are parent nodes (categories) that end in one leaf node (item). The smaller size of the first box compared to the second box indicates to the user with a quick viewing of the different sizes of the boxes that the second box is associated with a larger number of hierarchical levels/generations than the first box. Therefore, as applied to a common hierarchy, the disclosed techniques allow the user to immediately and efficiently view and compare the hierarchical structures associated with the various boxes of the category-counted treemap, without requiring the user to repeatedly interact with a conventional treemap UI to drill down through multiple layers of node properties as in prior approaches, thus improving the efficiency in the functioning of the computer itself relative to these prior approaches.

As applied to an inclusive hierarchy, the disclosed techniques generate and display a category-counted treemap that more accurately represents the number of actual items associated with each box of the category-counted treemap. For example, a first box representing a first parent node that includes one leaf node (item) will have a smaller computed size than a second box representing a second parent node that includes multiple hierarchy levels/generations of descendent nodes that are parent nodes (categories) that end in one leaf node (item). The smaller size of the first box compared to the second box indicates to the user with a quick viewing of the different sizes of the boxes that the second box is associated with a larger number of actual items than the first box. Therefore, as applied to an inclusive hierarchy, the disclosed techniques allow the user to immediately and efficiently view and compare the number of actual items associated with the various boxes of the category-counted treemap, without requiring the user to repeatedly interact with a conventional treemap UI to drill down through multiple layers of node properties as in prior approaches, thus improving the efficiency in the functioning of the computer itself relative to these prior approaches.

Aspects of the subject matter described herein are set out in the following numbered clauses.
1. In some embodiments, a computer-implemented method for generating and displaying treemaps representing tree hierarchies comprises receiving, via a treemap user interface, a user selection to view a treemap of a tree hierarchy, determining, for a first parent node included in a plurality of nodes of the tree hierarchy, a total number of descendent nodes of the first parent node within the tree hierarchy, computing, for the first parent node, a first size of a first box based on the total number of descendent nodes of the first parent node, and displaying to the user, via the treemap user interface, the treemap that represents the tree hierarchy and includes the first box, wherein the first box represents the first parent node and has the first size.
2. The computer-implemented method of clause 1, wherein the descendent nodes of the first parent node include at least one child node that also comprises a parent node and is included in the total number of descendent nodes determined for the first parent node.
3. The computer-implemented method of clauses 1 or 2, wherein the descendent nodes of the first parent node include at least one child node that comprises a leaf node and is included in the total number of descendent nodes determined for the first parent node.
4. The computer-implemented method of any of clauses 1-3, further comprising computing a size scaler based on a total number of nodes included in the plurality of nodes included in the tree hierarchy, wherein the first size of the first box is further computed based on the size scaler.
5. The computer-implemented method of any of clauses 1-4, wherein displaying the first box includes offset nesting the first box inside a second box within the treemap, wherein the second box represents a second parent node included in the tree hierarchy, and the first parent node comprises a sole direct child node of the second parent node within the tree hierarchy.
6. The computer-implemented method of any of clauses 1-5, wherein offset nesting the first box inside the second box includes displaying the first box and the second box as two distinct concentric boxes within the treemap.
7. The computer-implemented method of any of clauses 1-6, wherein offset nesting the first box inside the second box includes displaying a gap portion between the first box and the second box within the treemap.
8. The computer-implemented method of any of clauses 1-7, further comprising, for each additional node included in the tree hierarchy computing a particular size of a particular box for the additional node based on a total number of descendent nodes within the tree hierarchy that are associated with the additional node, and displaying, via the treemap user interface, the particular box within the treemap that represents the remaining node and has the particular size.
9. The computer-implemented method of any of clauses 1-8, further comprising receiving, via the treemap user interface, a search input, identifying a set of boxes within the treemap that match the search input, and visually highlighting the set of boxes within the treemap.
10. The computer-implemented method of any of clauses 1-9, wherein visually highlighting the set of boxes within the tree map includes displaying each box included in the set of boxes as a semi-transparent box having a predetermined darkness and a predetermined color.
11. In some embodiments, one or more non-transitory computer-readable media include instructions that, when executed by one or more processors, cause the one or more processors to generate and display treemaps representing tree hierarchies by performing the steps of receiving, via a treemap user interface, a user selection to view a treemap of a tree hierarchy, determining, for a first parent node included in a plurality of nodes of the tree hierarchy, a total number of descendent nodes of the first parent node within the tree hierarchy, computing, for the first parent node, a first size of a first box based on the total number of descendent nodes of the first parent node, and displaying to the user, via the treemap user interface, the treemap that represents the tree hierarchy and includes the first box, wherein the first box represents the first parent node and has the first size.
12. The one or more non-transitory computer-readable media of clause 11, wherein the descendent nodes of the first parent node include at least one child node that also comprises a parent node and is included in the total number of descendent nodes determined for the first parent node.
13. The one or more non-transitory computer-readable media of clauses 11 or 12, wherein the descendent nodes of the first parent node include at least one child node that comprises a leaf node and is included in the total number of descendent nodes determined for the first parent node.
14. The one or more non-transitory computer-readable media of any of clauses 11-13, further comprising computing a size scaler based on a total number of nodes included in the plurality of nodes included in the tree hierarchy, wherein the first size of the first box is further computed based on the size scaler.
15. The one or more non-transitory computer-readable media of any of clauses 11-14, wherein displaying the first box includes offset nesting the first box inside a second box within the treemap, wherein the second box represents a second parent node included in the tree hierarchy, and the first parent node comprises a sole direct child node of the second parent node within the tree hierarchy.
16. The one or more non-transitory computer-readable media of any of clauses 11-15, further comprising receiving, via the treemap user interface, a selection of a second box within the treemap, and performing, via the treemap user interface, a zoom-in operation focusing on the second box within the treemap.
17. The one or more non-transitory computer-readable media of any of clauses 11-16, wherein the treemap user interface only displays the second box within the treemap.
18. The one or more non-transitory computer-readable media of any of clauses 11-17, further comprising receiving, via the treemap user interface, a search input, identifying a set of boxes within the treemap that match the search input, and visually highlighting the set of boxes within the treemap.
19. The one or more non-transitory computer-readable media of any of clauses 11-18, further comprising displaying a set of information cards corresponding to the set of boxes, wherein a particular information card corresponding to a particular matching box includes metadata associated with the particular box.
20. In some embodiments, a computer system comprises a memory that includes instructions, and at least one processor that is coupled to the memory and, upon executing the instructions, generate and display treemaps representing tree hierarchies by performing the steps of receiving, via a treemap user interface, a user selection to view a treemap of a tree hierarchy, determining, for a first parent node included in a plurality of nodes of the tree hierarchy, a total number of descendent nodes of the first parent node within the tree hierarchy, computing, for the first parent node, a first size of a first box based on the total number of descendent nodes of the first parent node, and displaying to the user, via the treemap user interface, the treemap that represents the tree hierarchy and includes the first box, wherein the first box represents the first parent node and has the first size.

Any and all combinations of any of the claim elements recited in any of the claims and/or any elements described in this application, in any fashion, fall within the contemplated scope of the present embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUIs, etc.) are, in various embodiments, stored in the memory/memories shown in the relevant system figure(s) and executed by the processor(s) shown in those same system figures.

Any combination of one or more computer readable medium(s) can be utilized. The computer readable medium can be a computer readable signal medium or a computer readable storage medium. A computer readable storage medium can be, for example, but not limited to, an electronic, non-transitory, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for generating and displaying treemaps representing tree hierarchies, the method comprising:
receiving, via a treemap user interface, a user selection to view a treemap of a tree hierarchy;
determining, for a first parent node included in a plurality of nodes of the tree hierarchy, a total number of descendent nodes of the first parent node within the tree hierarchy;
computing, for the first parent node, a first size of a first box based on the total number of descendent nodes of the first parent node; and
displaying to the user, via the treemap user interface, the treemap that represents the tree hierarchy and includes the first box, wherein the first box represents the first parent node and has the first size.

2. The computer-implemented method of claim 1, wherein the descendent nodes of the first parent node include at least one child node that also comprises a parent node and is included in the total number of descendent nodes determined for the first parent node.

3. The computer-implemented method of claim 1, wherein the descendent nodes of the first parent node include at least one child node that comprises a leaf node and is included in the total number of descendent nodes determined for the first parent node.

4. The computer-implemented method of claim 1, further comprising computing a size scaler based on a total number of nodes included in the plurality of nodes included in the tree hierarchy, wherein the first size of the first box is further computed based on the size scaler.

5. The computer-implemented method of claim 1, wherein displaying the first box includes offset nesting the first box inside a second box within the treemap, wherein the second box represents a second parent node included in the tree hierarchy, and the first parent node comprises a sole direct child node of the second parent node within the tree hierarchy.

6. The computer-implemented method of claim 5, wherein offset nesting the first box inside the second box includes displaying the first box and the second box as two distinct concentric boxes within the treemap.

7. The computer-implemented method of claim 5, wherein offset nesting the first box inside the second box includes displaying a gap portion between the first box and the second box within the treemap.

8. The computer-implemented method of claim 1, further comprising, for each additional node included in the tree hierarchy:
computing a particular size of a particular box for the additional node based on a total number of descendent nodes within the tree hierarchy that are associated with the additional node; and
displaying, via the treemap user interface, the particular box within the treemap that represents the remaining node and has the particular size.

9. The computer-implemented method of claim 1, further comprising:
receiving, via the treemap user interface, a search input;
identifying a set of boxes within the treemap that match the search input; and
visually highlighting the set of boxes within the treemap.

10. The computer-implemented method of claim 9, wherein visually highlighting the set of boxes within the tree map includes displaying each box included in the set of boxes as a semi-transparent box having a predetermined darkness and a predetermined color.

11. One or more non-transitory computer-readable media including instructions that, when executed by one or more processors, cause the one or more processors to generate and display treemaps representing tree hierarchies by performing the steps of:
receiving, via a treemap user interface, a user selection to view a treemap of a tree hierarchy;
determining, for a first parent node included in a plurality of nodes of the tree hierarchy, a total number of descendent nodes of the first parent node within the tree hierarchy;
computing, for the first parent node, a first size of a first box based on the total number of descendent nodes of the first parent node; and
displaying to the user, via the treemap user interface, the treemap that represents the tree hierarchy and includes the first box, wherein the first box represents the first parent node and has the first size.

12. The one or more non-transitory computer-readable media of claim 11, wherein the descendent nodes of the first parent node include at least one child node that also comprises a parent node and is included in the total number of descendent nodes determined for the first parent node.

13. The one or more non-transitory computer-readable media of claim 11, wherein the descendent nodes of the first parent node include at least one child node that comprises a leaf node and is included in the total number of descendent nodes determined for the first parent node.

14. The one or more non-transitory computer-readable media of claim 11, further comprising computing a size scaler based on a total number of nodes included in the plurality of nodes included in the tree hierarchy, wherein the first size of the first box is further computed based on the size scaler.

15. The one or more non-transitory computer-readable media of claim 11, wherein displaying the first box includes offset nesting the first box inside a second box within the treemap, wherein the second box represents a second parent node included in the tree hierarchy, and the first parent node comprises a sole direct child node of the second parent node within the tree hierarchy.

16. The one or more non-transitory computer-readable media of claim 11, further comprising:
receiving, via the treemap user interface, a selection of a second box within the treemap; and
performing, via the treemap user interface, a zoom-in operation focusing on the second box within the treemap.

17. The one or more non-transitory computer-readable media of claim 16, wherein the treemap user interface only displays the second box within the treemap.

18. The one or more non-transitory computer-readable media of claim 11, further comprising:
receiving, via the treemap user interface, a search input;
identifying a set of boxes within the treemap that match the search input; and
visually highlighting the set of boxes within the treemap.

19. The one or more non-transitory computer-readable media of claim 18, further comprising displaying a set of information cards corresponding to the set of boxes, wherein a particular information card corresponding to a particular matching box includes metadata associated with the particular box.

20. A computer system comprising:
a memory that includes instructions; and
at least one processor that is coupled to the memory and, upon executing the instructions, generate and display treemaps representing tree hierarchies by performing the steps of:
receiving, via a treemap user interface, a user selection to view a treemap of a tree hierarchy;
determining, for a first parent node included in a plurality of nodes of the tree hierarchy, a total number of descendent nodes of the first parent node within the tree hierarchy;
computing, for the first parent node, a first size of a first box based on the total number of descendent nodes of the first parent node; and
displaying to the user, via the treemap user interface, the treemap that represents the tree hierarchy and includes the first box, wherein the first box represents the first parent node and has the first size.
